(19) United States
(12) Patent Application Publication
(10) Pub. No.: US 2002/0184335 A1
(43) Pub. Date: Dec. 5, 2002

(54) System and method for transferring selected imaging data from a digital camera

(76) Inventors: Shell S. Simpson, Boise, ID (US); Ward S. Foster, Boise, ID (US); Kris R. Livingston, Boise, ID (US)

Correspondence Address: HEWLETT-PACKARD COMPANY, Intellectual Property Administration, P. O. Box 272400, Fort Collins, CO, 80527-2400, US

(21) Appl. No.: 09/874,183

(22) Filed: Jun. 4, 2001

(51) Int. Cl. G06F 15/16; G06F 15/173

(52) U.S. Cl. 709/217; 709/238

(57) ABSTRACT

A system and method for selectively transferring imaging data from a digital camera to a personal imaging repository located on a client computer connected to a web server computer providing a camera web service via the Internet, which includes a personal imaging repository associated with a particular user for storing imaging data that is to be accessed by requested web services, a camera content for storing selected imaging data from the digital camera onto the personal imaging repository responsive to user selection, and a camera web service for providing the camera content and transferring the selected imaging data from the digital camera to the personal imaging repository. The personal imaging repository acts as an exchange infrastructure between the imaging data and available web services.

The present invention generally relates to an improved system and method for transferring selected imaging data from a digital camera to a personal imaging repository. More specifically, it relates to an improved system and method for transferring selected imaging data from a digital camera to a personal imaging repository, having an imaging data store for storing the imaging data and a composition store for storing imaging compositions having links of the imaging data serviced as a single unit, located on a computer connected to a camera web server providing a camera web service via the Internet.

To access imaging data stored on a digital camera generally requires that the digital camera be connected to a personal computer (“PC”) having specialized software that allows the user to select images. These selected images are then stored on the user's PC hard disk. However, in order for the user to use these selected images, the user must typically interact with yet another software program. For example, it is currently quite popular to convert the images to a Portable Document Format (“PDF”) file. However, it should be understood that the term “imaging data” as read herein refers digital data capable of being represented as two dimensional graphics, such as a PDF file or a Joint Photographic Experts Group (“JPEG”) file. Currently, because various programs must be used by the user to utilize the imaging data, it is often necessary for the user to know exactly where these selected images were stored when they were transferred from the digital camera, and it can be difficult to locate the images because of the use of multiple programs.

### BRIEF SUMMARY OF THE INVENTION

The present invention is directed to an improved system and method for transferring selected imaging data from a digital camera to a personal imaging repository. More particularly, the system and method for transferring selected imaging data from a digital camera to a personal imaging repository located on or operatively connected to a computer connected to a web server providing a camera web service via the Internet.

The present invention provides a system that includes a personal imaging repository associated with a particular user for storing imaging data that is to be accessed by requested web services, a camera content for storing selected imaging data from the digital camera onto the personal imaging repository responsive to user selection, and a camera web service for providing the camera content and transferring the selected imaging data from the digital camera to the personal imaging repository. The personal imaging repository acts as an exchange infrastructure between the imaging data and available web services.

The present invention further provides a method that includes the steps of requesting web content from the camera web service by the browser, responding to the request by supplying camera content to the browser, displaying and executing the camera content by the browser, transferring selected imaging data to the camera content by the digital camera, and saving the selected imaging data to the personal imaging repository.

### DESCRIPTION OF THE DRAWINGS

FIG. 1 is a preferred architectural diagram of a network system in which the present invention can be implemented;

FIG. 2 is an architectural diagram of a second network system in which the present invention can be implemented;

FIG. 3 is an architectural diagram of a third network system in which the present invention can be implemented;

FIG. 4 is a flowchart illustrating the preferred functionality of the transfer method of the present invention;

FIG. 5 is a flowchart illustrating the preferred functionality of the transfer method shown in FIG. 4; and,

FIG. 6 illustrates an exemplary page of the camera content.

### GLOSSARY OF TERMS AND ACRONYMS

The following terms and acronyms are used throughout the detailed description:

Client-Server. A model of interaction in a distributed system in which a program at one site sends a request to a program at another site and waits for a response. The requesting program is called the “client,” and the program which responds to the request is called the “server.” In the context of the World Wide Web (discussed below), the client is a “Web browser” (or simply “browser”) which runs on the computer of a user; the program which responds to browser requests by serving Web pages, or other types of Web content, is commonly referred to as a “Web server.”

Composition store. Composition store refers to a network service or a storage device for storing imaging composition(s) that can be accessed by the user or other web services.

Content. A set of executable instructions that is served by a server to a client and that is intended to be executed by the client so as to provide the client with certain functionality. Web content refers to content that is meant to be executed by operation of a Web browser. Web content, therefore, may non-exhaustively include one or more of the following: HTML code, SGML code, XML code, XSL code, CSS code, Java applet, JavaScript and C-“Sharp” code.

Exchange infrastructure. An exchange infrastructure is a collection of services distributed throughout a network that stores imaging data associated with a particular user through a user profile.

Hyperlink. A navigational link from one document to another, from one portion (or component) of a document to another, or to a Web resource, such as a Java applet. Typically, a hyperlink is displayed as a highlighted word or phrase that can be selected by clicking on it using a mouse to jump to the associated document or document portion or to retrieve a particular resource.

Hypertext System. A computer-based informational system in which documents (and possibly other types of data entities) are linked together via hyperlinks to form a user-navigable “web.”

Imaging composition. An imaging composition comprises links to imaging data serviced as a single unit.

Imaging data. Imaging data refers to digital data capable of being represented as two dimensional graphics, such as a Portable Document Format (“PDF”) file or a Joint Photographic Experts Group (“JPEG”) file.

Imaging data store. Imaging data store refers to a network service or a storage device for storing imaging data that can be accessed by the user or other network services. The imaging data store preferably accepts the imaging data in multiple standard file formats, and the imaging data is converted into these file formats when necessary depending on the implementation.

Internet. A collection of interconnected or disconnected networks (public and/or private) that are linked together by a set of standard protocols (such as TCP/IP and HTTP) to form a global, distributed network. (While this term is intended to refer to what is now commonly known as the Internet, it is also intended to encompass variations which may be made in the future, including changes and additions to existing standard protocols.)

World Wide Web (“Web”). Used herein to refer generally to both (i) a distributed collection of interlinked, user-viewable hypertext documents (commonly referred to as Web documents or Web pages) that are accessible via the Internet, and (ii) the client and server software components which provide user access to such documents using standardized Internet protocols. Currently, the primary standard protocol for allowing applications to locate and acquire Web documents is HTTP, and the Web pages are encoded using HTML. However, the terms “Web” and “World Wide Web” are intended to encompass future markup languages and transport protocols which may be used in place of (or in addition to) HTML and HTTP.

Web Site. A computer system that serves informational content over a network using the standard protocols of the World Wide Web. Typically, a Web site corresponds to a particular Internet domain name, such as “HP.com,” and includes the content associated with a particular organization. As used herein, the term is generally intended to encompass both (i) the hardware/software server components that serve the informational content over the network, and (ii) the “back end” hardware/software components, including any non-standard or specialized components, that interact with the server components to perform services for Web site users. Importantly, a Web Site can have additional functionality, for example, a Web site may have the ability to print documents, scan documents, etc.

HTML (HyperText Markup Language). A standard coding convention and set of codes for attaching presentation and linking attributes to informational content within documents. (HTML 2.0 is currently the primary standard used for generating Web documents.) During a document authoring stage, the HTML codes (referred to as “tags”) are embedded within the informational content of the document. When the Web document (or HTML document) is subsequently transferred from a Web server to a browser, the codes are interpreted by the browser and used to display the document. Additionally in specifying how the Web browser is to display the document, HTML tags can be used to create links to other Web documents (commonly referred to as “hyperlinks”). For more information on HTML, see Ian S. Graham, The HTML Source Book, John Wiley and Sons, Inc., 1995 (ISBN 0471-11894-4).

HTTP (HyperText Transport Protocol). The standard World Wide Web client-server protocol used for the exchange of information (such as HTML documents, and client requests for such documents) between a browser and a Web server. HTTP includes a number of different types of messages which can be sent from the client to the server to request different types of server actions. For example, a “GET” message, which has the format GET <URL>, causes the server to return the document or file located at the specified URL.

URL (Uniform Resource Locator). A unique address which fully specifies the location of a file or other resource on the Internet or a network. The general format of a URL is protocol: //machine address:port/path/filename.

User Information. User information is identification and security information used in accessing imaging composition(s) and imaging data associated with a particular user profile. It is preferably accessed either directly or indirectly through methods provided by an extension component integrated into the web browser.

PDA (Personal Digital Assistant). A small hand-held computer used to write notes, track appointments, email and web browser with generally with far less storage capacity than a desktop computer.

Personal imaging repository. A personal imaging repository is a conceptual term describing the exchange infrastructure used to exchange imaging composition and imaging data with web services. Users are associated with their imaging data through user profiles.

### DETAILED DESCRIPTION

Broadly stated, the present invention is directed to an improved system and method for transferring selected imaging data from a digital camera to a personal imaging repository. The system and method provide for the transferring of imaging data to a personal imaging repository that is associated with the user. In addition, the personal imaging repository acts as an exchange infrastructure for any available web services. As a result, users can utilize images from a digital camera more readily and easily.

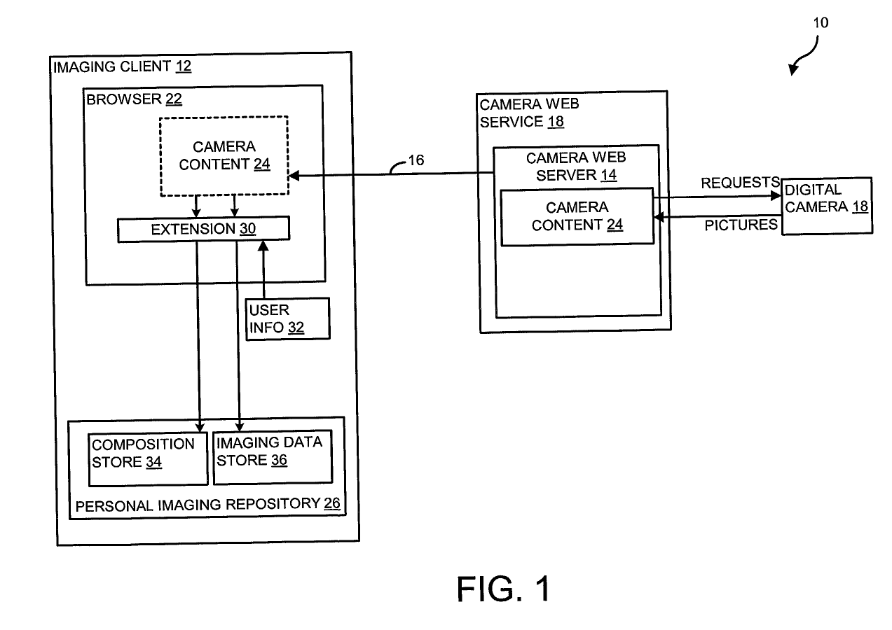

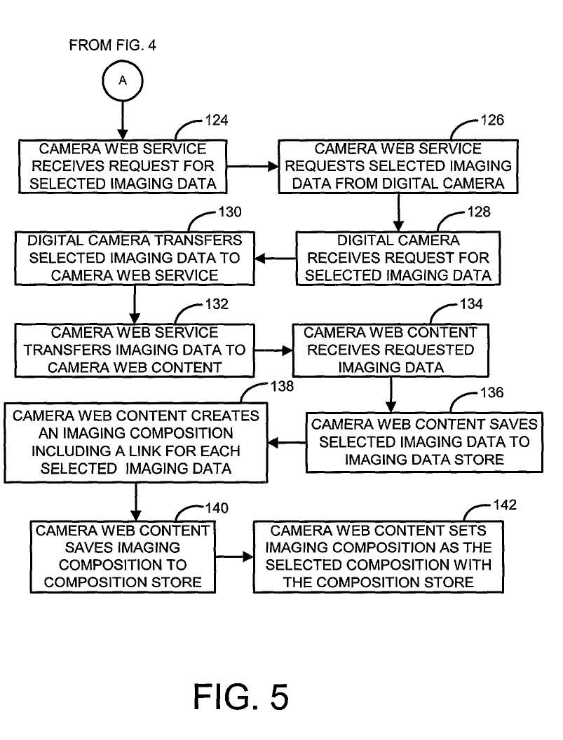

The preferred network system in which the present invention can be implemented is shown in FIG. 1 and indicated generally at 10. An imaging client computer 12 is connected to a camera web server computer 14 via an Internet connection 16. The camera web server computer 14 provides a camera web service 18 linked to a digital camera 20 for displaying imaging data stored in the camera. The imaging client computer 12 can access the camera web service 18 through a browser 22. When the browser 22 browses to the web service 18, the camera web server 14 responds with a camera content 24 for selectively storing the imaging data onto a personal imaging repository 26 (an example page of the camera content is shown in FIG. 5). The camera content 24 is then executed by the browser 22.

The browser 22 also includes an extension component 30, which provides access to user information 32 that associates the camera content 24 with the personal imaging repository 26 that belongs to this user. Although it is shown and preferred that the extension component for accessing user information located on the browser of the imaging client computer, the user information can also be implemented in other places in the network system. In fact, other ways to implement access to the user information can be used. For example, signed content can be used with digital signature security technologies. There are unlimited number of ways to implementing the security system in accessing the user information and the personal imaging repository. However, these other implementation are contemplated and within the scope of the present invention.

In the present invention, it is preferred that the personal imaging repository 26 includes a composition store 34 for storing imaging composition(s) of the imaging data that are serviced as a single unit and an imaging data store 36, i.e., digital memory, for storing the imaging data. An imaging composition preferably comprises links to the imaging data, which can be located at another web service's site. As a result, the composition store 34 stores only the imaging compositions. The imaging data store 36, on the other hand, is any imaging data store located on any computer that contains the imaging data. More specifically, each web service can have its own imaging data store 36 available to the public.

For example, at some earlier time, a user may print an article from a web service site, resulting in an imaging composition being created and stored in the user's composition store. The imaging composition contains only the link to the imaging data for this article stored on the web service site. Consequently, the imaging data for the article is not located in the imaging data store that is stored on the imaging client 12. Rather, the imaging data is stored in the imaging data store on the web service site. Of course, users will have an imaging data store that belongs to their user identification where they can store imaging data, which is the imaging data store shown in the imaging client. As a result, the term “personal imaging repository” 26 is meant as a conceptual term for an exchange infrastructure between the imaging data and the available web services. Similarly, the term “web” denotes millions of distinct servers that comprise the web. However, the web does not actually do anything itself. Similarly, the servers serving the composition store and the imaging data store are physical implementations of the personal imaging repository as a concept.

In this preferred implementation, whenever a user requests that selected imaging data is to be transferred from a digital camera, the imaging data will be automatically stored in the personal imaging repository 26 that is associated with this user. In other words, users will no longer be asked to indicate a place where the imaging data should be copied to. Rather, the imaging data will automatically be downloaded to the user's personal imaging repository 26. From the personal imaging repository 26, other web services are configured to look into the personal imaging repository 26 to access particular imaging data that have been requested for servicing.

As a result, the personal imaging repository 26 becomes the exchange infrastructure for the imaging data for the web services. In other words, the personal imaging repository 26 acts as an exchange infrastructure for the imaging data for these available web services. The user no longer has to remember in which directory they placed the selected imaging data. When the user requests web services for any of the imaging data stored in the personal imaging repository, the requested web service is configured to access the active imaging data stored in the personal imaging repository. Furthermore, the user will no longer be asked where to store these selected imaging data, because they are automatically stored in the personal imaging repository when the user uses the camera web service for transferring imaging data from a digital camera. In fact, since the camera web service is web-based, it is unnecessary for the user to download and install software for transferring data from the digital camera.

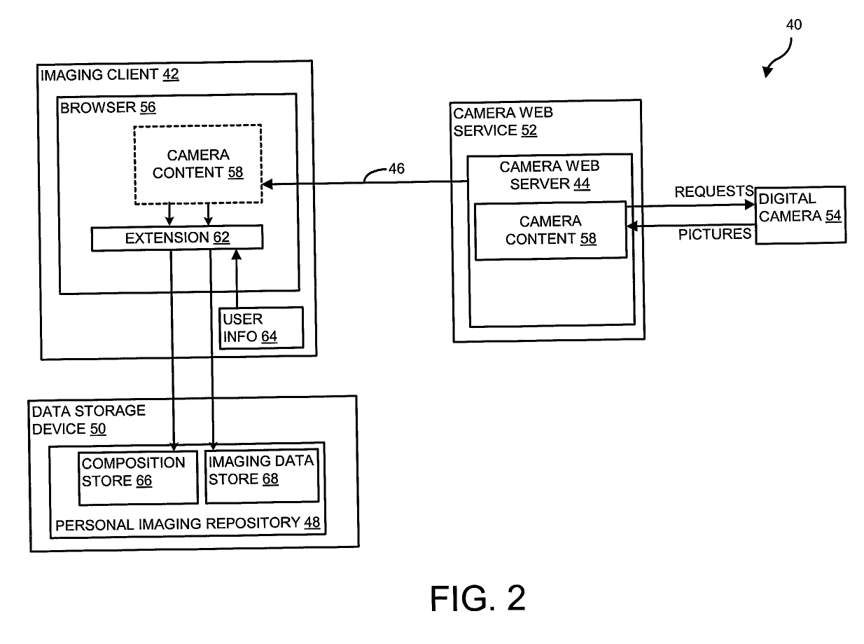

It should be noted that the personal imaging repository 26 can represent any type of data storage device. In fact, the data storage device 26 does not necessarily have to be located within the imaging client computer 12. The personal imaging repository 26 can be located, for example, on another storage medium, which the client machine can access through alternative communication links. Although it is currently preferred to include the personal imaging repository 26 with the imaging client, this would likely change as the bandwidth becomes faster and the popularity of the personal digital assistant (“PDA”) increases. These alternative implementations are contemplated, and should be considered to be within the scope of the present invention. One preferred embodiment that is more tailored to faster bandwidth or any client machine with limited storage capacity is shown in FIG. 2.

A second network system is shown in FIG. 2, and indicated generally at 40. In this implementation, multiple users can utilize the same imaging client computer 42 that is connected to a camera web server 44 through the Internet 46. In this implementation, the imaging client computer 42 can include client computers that have less storage memory, such as a Personal Digital Assistant (“PDA”) or a laptop. Because of the limit on the storage memory, the personal imaging repository 48 for storing user's imaging data is located on a data storage device 50 that, although linked to the imaging client computer, is separated physically from the imaging client computer 42, which can also be a server computer or a linked client machine.

Similarly, the camera web server 44 provides a web service 52 representing a linked digital camera 54 for transferring the imaging data. Using a browser 56 located on the imaging client computer 42, the user browses to the web service 52, which responds by displaying a camera content 58. The browser 56 then executes the camera content 58. The browser 56 further includes an extension component 62 providing access to user information 64 that can associate the camera content 58 to the personal imaging repository 48 assigned to this user. The personal imaging repository, in this second embodiment, similarly includes a composition store 66 for storing imaging compositions and an imaging data store 68 for storing imaging data.

In this implementation, users can access the system 40 and their personal imaging repository 48 from any imaging client computers that have a browser 56 having their user information 64 and Internet access. As a result of the flexibility of the Internet, it is possible for users to access the system 44 and their personal imaging repository 48 using a standard PDA and/or a wireless web phone. This embodiment provides a more flexible access to the personal imaging repository 48, which may be more desirable as technology improves.

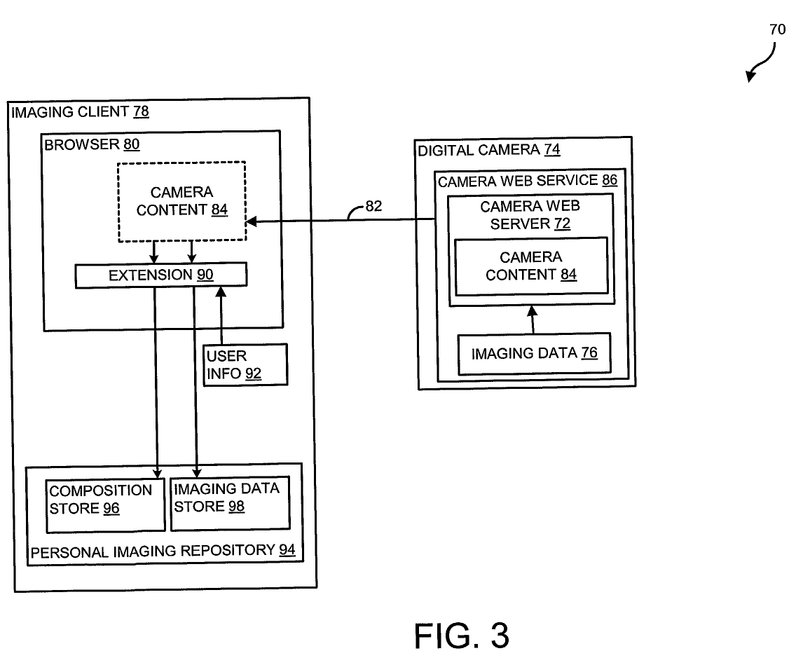

Finally, a third embodiment of the system in which the present invention can be implemented is shown in FIG. 3 and indicated generally at 70. In this embodiment, since the camera web server 72 is located in the digital camera 74, unlike the previous embodiments, it is unnecessary for the digital camera to establish a link to the camera web server. As shown, the imaging data 76 from the digital camera 74 are already linked to the web server 72 without additional connections. An imaging client 78 with a browser 80 that connects to the camera web server 72, which is located in the digital camera 74, over the Internet 82.

Similarly, the camera web server 72 sends a camera content 84 that allows the user to select imaging data from the digital camera for transfer responsive to the user browsing to the camera web service 86. The camera content 84, in turn, is executed by the browser 80, which includes an extension component 90 with user information 92 that links the camera content 84 to the personal imaging repository 94. Although it is shown that the personal imaging repository 94 is located in the imaging client computer 78, it is also within the scope of the present invention that the personal imaging repository be located on a data storage device that is physically located outside of the imaging client computer as well. A composition store 96 and an imaging data store 98 are similarly found in the personal imaging repository 94. Imaging compositions are stored in the composition store 96, while the imaging data are stored in the imaging data store 98.

It should be noted that there are unlimited number of ways to implement the topology of the network system. For example, although not shown, the camera web service can also reside on the imaging client 12, instead of being on a separate camera web server. These various implementations are contemplated and should be considered to be within the scope of the present invention.

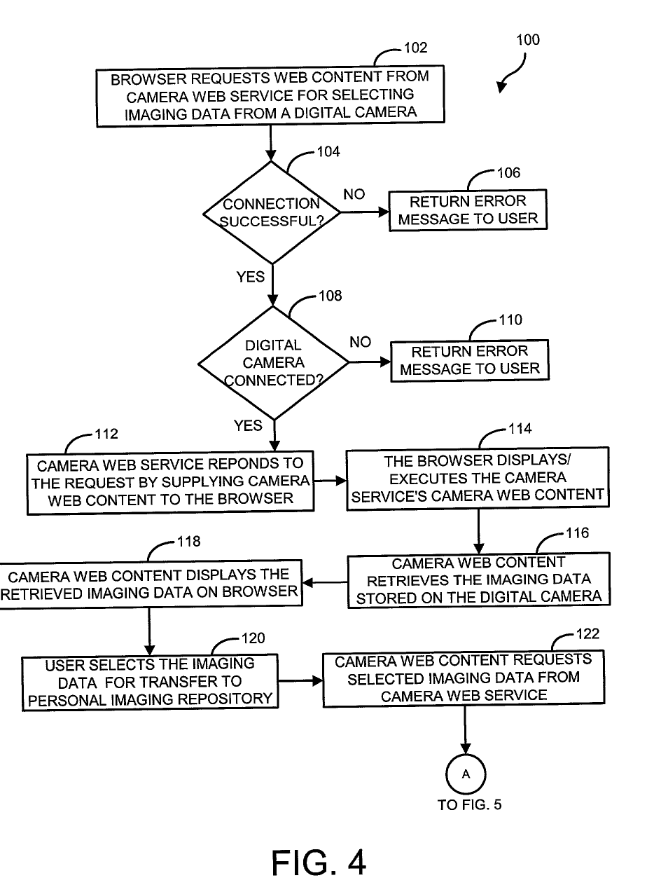

Turning to an important aspect of the present invention, a flow chart of the preferred functionality of the transfer method is shown in FIGS. 4 and 5, and indicated generally at 100. The browser first requests a web content from the camera web service for the selection of imaging data stored on a linked digital camera (block 102). It is then determined whether the imaging client computer has established a successful connection with the camera web service (block 104). If a connection has not been established (block 104), the imaging client computer returns an error message to the user (block 106), which then ends the process. Otherwise, the camera web service determines whether a digital camera is connected to it (block 108), and again an error message will be returned to the user (block 110) if the connection to a digital camera cannot be found.

Once a connection to a digital camera is established (block 108), the camera web service responds to the request by supplying camera content to the browser (block 112), which the browser displays and executes the camera content (block 114). After execution of the camera content (block 114), the camera content next retrieves the imaging data stored on the digital camera (block 116). The retrieved imaging data is displayed to the user on the browser for selection (block 118), and an exemplary page of the camera content is displayed. The user selects the desired imaging data to be transferred to the personal imaging repository (block 120) by interacting with the camera content, which prompts the camera content to request the selected imaging data from the camera web service (block 122).

After the camera web service receives the request from the camera content (block 124) (shown in FIG. 5), the camera web service requests the selected imaging data from the digital camera (block 126). The digital camera receives the request from the camera web service for the selected imaging data (block 128), and accordingly transfers the selected imaging data to the camera web service (block 130). After receiving the transferred selected imaging data from the digital camera (block 130), the camera web service, in turn, transfers the imaging data to the camera content (block 132). The camera content receives the selected imaging data from the camera web service (block 134).

Consequently, the camera web content, executed and displayed on the browser of the imaging client, saves the transferred selected imaging data to the imaging data store (block 136), and creates an imaging composition including a link for each selected imaging data (block 138). The camera web content accordingly saves the imaging composition in the composition store (block 140), and the imaging composition is set as a selected imaging composition (block 142). Because the imaging composition is set as the selected composition, it will be used by web services that make use of the selected composition of the personal imaging repository.

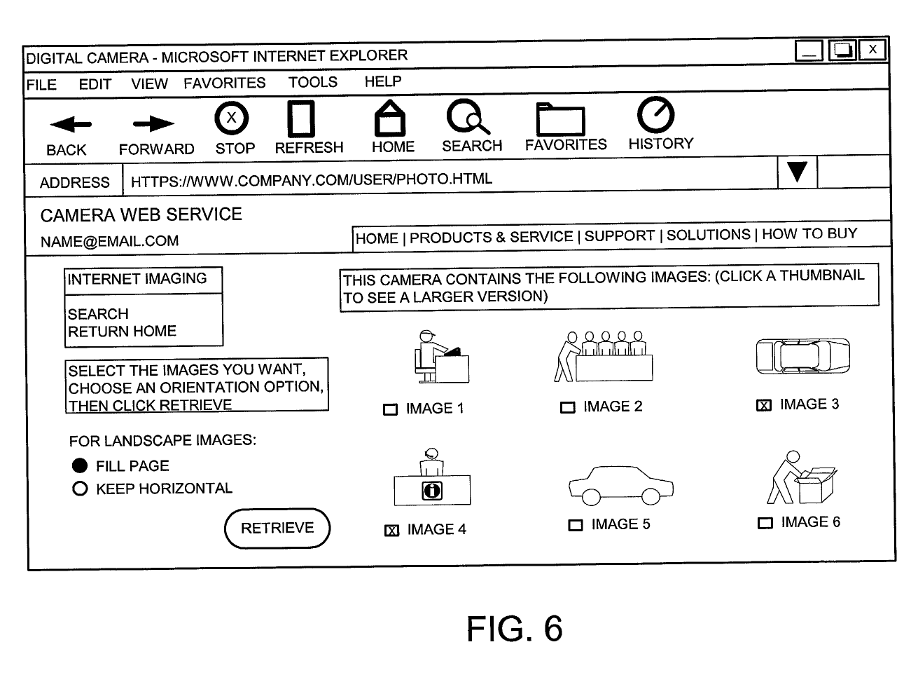

An exemplary page of the camera content is shown in FIG. 6. The camera content shows a total of six images that can be transferred from the digital camera. In this example, image 3 and image 4 are selected and ready to be transferred. Optional image features may be included, such as having the image fill the whole page. Once the user has selected the desired images, the user can then press the retrieve button on the camera content to initiate the transfer process. Only the selected images (e.g., image 3 and image 4) are uploaded to the personal imaging repository that is associated with this user's information, which is found through the extension component. The user need not know where exactly these images are stored, because the user can use these images at a later time by simply browsing another web page that is set up to list all the imaging data stored on the personal imaging repository.

From the foregoing description, it should be understood that an improved system and method for selectively transferring imaging data from a digital camera to a personal imaging repository has been shown and described, which has many desirable attributes and advantages. The system and method provides for the transferring imaging data from a digital camera to a personal imaging repository that can be easily selected by the user using a browser. Furthermore, because the personal imaging repository is set up as an exchange infrastructure between the imaging data and web services, users no longer need to recall where their previous transferred images are located on their hard disk. The present invention allows the user to selectively transfer imaging data from a digital camera that allows for greater flexibility for the user. In addition, the user can manage their imaging data more easily with fewer limitations.

While various embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

What is claimed is:

1. A system for transferring selected imaging data from a digital camera to a personal imaging repository located on a client computer connected to a web server computer providing a camera web service via the Internet, comprising:
a personal imaging repository associated with a particular user for storing imaging data that is to be accessed by requested web services;
a camera content for storing selected imaging data from the digital camera onto said personal imaging repository responsive to user selection; and,
a camera web service for providing said camera content and transferring the selected imaging data from the digital camera to said personal imaging repository;
wherein said personal imaging repository is an exchange infrastructure between the imaging data and available web services.

2. The system as defined in claim 1 further comprising a browser provided by the client computer for displaying said camera content to the user.

3. The system as defined in claim 1 wherein said personal imaging repository comprises an imaging data store for storing the imaging data.

4. The system as defined in claim 1 wherein said personal imaging repository comprises a composition store for storing imaging compositions of the imaging data that are serviced as a single unit.

5. The system as defined in claim 4 wherein an imaging composition comprises imaging data or a link to the imaging data.

6. The system as defined in claim 1 wherein said camera web service is linked to the digital camera.

7. The system as defined in claim 1 wherein said camera web service is located in the digital camera.

8. The system as defined in claim 1 wherein said camera web service is located in a camera web server computer.

9. The system as defined in claim 1 wherein said camera web service is located in the imaging client computer.

10. The system as defined in claim 1 wherein said personal imaging repository is located on the client computer.

11. The system as defined in claim 1 wherein said personal imaging repository is located on another data storage device that is linked to the client computer.

12. The system as defined in claim 1 further comprising an extension component providing access to the user information for associating said camera content to said personal imaging repository.

13. A method for transferring selected imaging data from a digital camera to a personal imaging repository, having an imaging data store for storing the imaging data and a composition store for storing imaging compositions having links to the imaging data serviced as a single unit, the imaging data store and composition store being located on a computer connected to a camera web server providing a camera web service via the Internet, said method comprising:
requesting web content from the camera web service by the browser;
responding to the request by supplying camera content to the browser;
displaying and executing the camera content by the browser;
transferring selected imaging data to the camera content by the digital camera; and,
saving the selected imaging data to the personal imaging repository.

14. The method according to claim 13, wherein prior to said step of responding to the request, further comprising the steps of:
determining whether the connection with the camera web service is successful;
returning an error message to the user when the connection with the camera web service is not successful;
determining whether the camera web service has a link to the digital camera when the connection with the camera web service is successful; and,
returning an error message to the user when the connection with the camera web service does not have a link to the digital camera.

15. The method according to claim 13 wherein said step of displaying and executing the camera content further comprising the steps of:
retrieving a list of the imaging data stored on the digital camera by the camera content;
displaying the retrieved list of the imaging data on the browser for user selection; and,
selecting the displayed imaging data for transfer to personal imaging repository by the user.

16. The method according to claim 13, wherein prior to said step of transferring selected imaging data to the camera content, further comprising the steps of:
requesting selected imaging data from the web camera web service by the camera content;
receiving the request for the selected imaging data from the camera content by the camera web service;
requesting selected imaging data from the digital camera by the camera web service responsive to the request; and, receiving the request from the camera web service by the digital camera.

17. The method according to claim 15 further comprising the steps of:
transferring the selected imaging data to the camera web service by the digital camera responsive to the request;
transferring the selected imaging data to the camera content by the camera web service responsive to the request; and,
receiving the selected imaging data by the camera content.

18. The method according to claim 13 wherein said step of saving the selected imaging data to the personal imaging repository further comprising the steps of:
saving the selected imaging data to the imaging data store by the camera web content;
creating an imaging composition that includes a link for each selected imaging data by the camera web content;
saving imaging composition to the composition store by the camera web content; and,
setting the imaging composition as the selected composition with composition store.

19. A computer program product comprising a computer usable medium having computer readable program codes embodied in the medium that when executed causes a computer to:
request web content from the camera web service by the browser;
respond to the request by supplying camera content to the browser;
display and execute the camera content by the browser;
transfer selected imaging data to the camera content by the digital camera; and,
save the selected imaging data to the personal imaging repository.

20. A computer program product comprising a computer usable medium having computer readable program codes embodied in the medium that when installed in a computer having a browser that is connected to a camera web service linked to a digital camera with imaging data, the product causes the computer to:
display and execute a camera content from the camera web service on the browser;
retrieve a list of the imaging data stored on the digital camera;
display the retrieved list of the imaging data on the browser; and, request selected imaging data from the camera web service.

21. A computer program product comprising a computer usable medium having computer readable program codes embodied in the medium that when installed in a computer having a personal imaging repository with an imaging data store for storing the imaging data and a composition store for storing imaging compositions with links to the imaging data serviced as a single unit that is connected to a camera web service linked to a digital camera with imaging data, the product causes the computer to:
receive selected imaging data transferred from the camera web service;
save the selected imaging data to the imaging data store;
create an imaging composition that includes a link for each selected imaging data by the imaging client;
save the imaging composition to the composition store; and,
set the imaging composition as the selected composition with the composition store.

22. A computer program product comprising a computer usable medium having computer readable program codes embodied in the medium that when installed in a web service computer that is connected to a computer having a browser that is linked to a digital camera with imaging data and a personal imaging repository having an imaging data store for storing the imaging data and a composition store for storing imaging compositions with links to the imaging data serviced as a single unit, the product causes the web service computer to:
send a camera content responsive to a request for web content from a browser;
receive a request for selected imaging data from the browser;
request the selected imaging data from the digital camera; and,
transfer the selected imaging data from the digital camera to the camera content.

23. A computer program product comprising a computer usable medium having computer readable program codes embodied in the medium that when installed in a digital camera, having a camera web service and imaging data, connected to a computer having a browser that is linked to a personal imaging repository having an imaging data store for storing the imaging data and a composition store for storing imaging compositions with links to the imaging data serviced as a single unit, the product causes the digital camera to:
send a camera content responsive to a request for web content from a browser;
receive a request for selected imaging data from the browser; and,
transfer the selected imaging data stored on the digital camera to the camera content.
